(19) United States
(12) Patent Application Publication
(10) Pub. No.: US 2026/0320433 A1
(43) Pub. Date: Oct. 15, 2026

(54) ADAPTOR FOR MANAGING DATA FLOW IN AN INFERENCE PIPELINE, AND METHOD OF USING THEREOF

(71) Applicant: Nvidia Corporation, Santa Clara, CA (US)

(72) Inventors: Rohith BASAVARAJA, Bengaluru (IN); Vinay PRASAD V, BENGALURU (IN); Sharath RAMAMURTHY, Bangalore (IN); Chirag REWRI, Bangalore (IN)

(73) Assignee: Nvidia Corporation, Santa Clara, CA (US)

(21) Appl. No.: 19/177,789

(22) Filed: Apr. 14, 2025

(51) Int. Cl. G06N 5/04; H04L 49/00

(52) U.S. Cl. CPC G06N 5/04; H04L 49/3063

(57) ABSTRACT

The present disclosure provides an adaptor for managing data flow in an inference pipeline. The adaptor comprises a non-transitory memory device storing instruction code modules and at least one processor configured to execute the modules. The processor is configured to collect model metadata describing at least one machine-learning (ML) based inference model deployed within the inference pipeline, define a required ingress data format for interfacing the inference model based on the model metadata, employ an ingress adaptation module to receive an input data element from one or more data input sources and translate the input data element according to the ingress data format, and process the translated input data element through the inference model to generate at least one first inference result.

### FIELD OF INVENTION

The present disclosure relates to adaptive inference systems for machine learning models, and more particularly to an adaptive inference adaptor for managing data flow and optimizing performance in inference model pipelines.

### BACKGROUND

Machine learning and artificial intelligence have become increasingly prevalent in various industries, enabling advanced data analysis and decision-making capabilities. As these technologies evolve, there is a growing need for efficient deployment and management of inference models in production environments.

As organizations increasingly rely on machine learning models for decision support and automation, there is a growing demand for tools and systems that can streamline the deployment, management, and optimization of inference pipelines. Such solutions could potentially address challenges related to data handling, model performance, scalability, and integration with existing infrastructure.

Advancements in this area could lead to more efficient utilization of computational resources, improved model performance, and greater flexibility in deploying machine learning solutions across diverse application domains.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Inference models, trained on large datasets, are designed to make predictions or classifications based on input data. However, deploying these models in real-world scenarios presents several challenges. One such challenge is the diversity of data sources and formats that may need to be processed by the inference models. Data can come from various platforms, devices, and systems, each potentially using different data structures or protocols.

Another challenge in deploying inference models is the need for scalability and adaptability. As the volume and velocity of data increase, inference pipelines must be able to handle varying loads efficiently. This often requires dynamic resource allocation and the ability to adjust model configurations in response to changing conditions.

Furthermore, maintaining the accuracy and reliability of deployed models over time is a complex task. Models may experience performance degradation due to changes in the underlying data distribution or shifts in the operational environment. Continuous monitoring and periodic retraining of models are often necessary to ensure their ongoing effectiveness.

Data preprocessing and post-processing are also important aspects of inference pipelines. Raw input data may need to be transformed, normalized, or enriched before it can be effectively utilized by inference models. Similarly, the output of these models may require further processing or adaptation to integrate seamlessly with downstream systems or user interfaces.

The present invention addresses these challenges by providing an adaptive inference adaptor system that manages data flow and optimizes performance in inference model pipelines. This system may handle diverse data sources and formats through flexible ingress and egress adaptation modules, enabling seamless integration with various platforms and devices. The adaptor may support scalability and adaptability by incorporating dynamic resource allocation and configuration adjustment capabilities. To maintain model accuracy and reliability over time, the system may include continuous monitoring features and mechanisms for periodic model retraining. Additionally, the invention may offer robust data preprocessing and post-processing functionalities, allowing for efficient data transformation, normalization, and enrichment, as well as adaptation of model outputs for downstream systems and user interfaces.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 is a block diagram, depicting a computing device which may be included in an adaptor system for managing data flow in an inference pipeline, according to some embodiments of the present invention;

FIG. 2 illustrates a block diagram of an adaptor system for managing data flow in an inference pipeline, according to some embodiments of the present invention;

FIG. 3, is a block diagram, illustrating an implementation example, where an adaptor system of the present invention may receive a flow of telemetry data from one or more network devices;

FIG. 4 is a block diagram, depicting an implementation example where an adaptor system may process output data of at least one inference model, according to some embodiments of the invention;

FIG. 5 is a block diagram depicting a process of training, and deploying an ML-based inference model in an inference pipeline by an adaptor system, according to some embodiments of the invention;

FIG. 6 is a block diagram depicting a process of continuous management of an inference pipeline by an adaptor system, according to some embodiments of the invention; and

FIG. 7 is a flow diagram depicting a method of managing data flow in an inference pipeline by at least one processor, according to embodiments of the invention.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

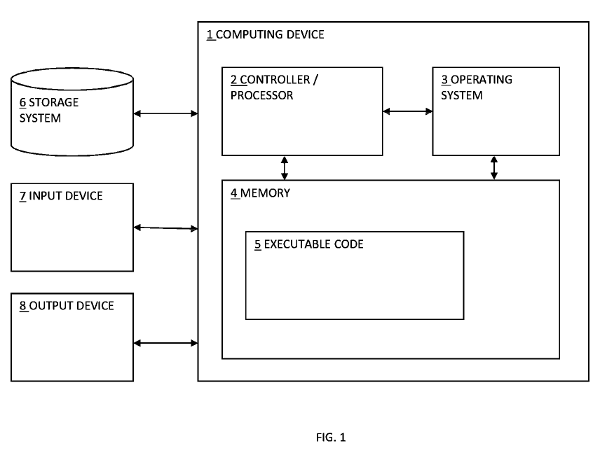

Reference is now made to FIG. 1, which is a block diagram depicting a computing device, which may be included within an embodiment of an adaptor system 100 (also denoted herein “adaptor 100” and “system 100”) for managing data flow in an inference pipeline, according to some embodiments of the invention.

Computing device 1 may include the following components: Processor or controller 2 (e.g., a central processing unit (CPU)), Operating system 3, Memory 4, Executable code 5, Storage system 6, Input devices 7, and/or Output devices 8.

Processor 2 may be a central processing unit (CPU), a microprocessor, an electronic circuit, an integrated circuit, or other type of circuitry configured to interpret and execute computer instructions and/or to process data. Processor 2 may be a single processing unit or may include multiple processing units. Processor 2 may include a general-purpose processor, a digital signal processor (DSP), an application-specific integrated circuit (ASIC), a field programmable gate array (FPGA) or other programmable logic device, discrete gate or transistor logic, discrete hardware components, or any combination thereof.

Operating system 3 may manage computer hardware and software resources and provide common services for computer programs. Operating system 3 may be implemented using any suitable operating system, for example, Windows®, macOS®, iOS®, Linux®, Unix®, z/OS®, Android™, or any other suitable operating system.

Memory 4 may be configured to store data and/or instructions. Memory 4 may include, for example, random access memory (RAM), read only memory (ROM), programmable read only memory (PROM), erasable programmable read only memory (EPROM), electronically erasable programmable read only memory (EEPROM), flash memory, solid state memory, hard disk drives, optical media, or any other suitable memory. In some embodiments, memory 4 may be a non-transitory computer-readable storage medium.

Executable code 5 may include instructions that, when executed by processor 2, cause processor 2 to perform operations related to Adaptive Inference Adaptor for Inference Model (NIM) Deployment. Executable code 5 may be stored in memory 4 and/or storage system 6.

Storage system 6 may include one or more storage devices and/or systems, such as hard disk drives, solid-state drives, tape drives, optical drives, storage area networks, cloud storage systems, or any other suitable storage devices or systems. Storage system 6 may store data and/or instructions used by processor 2 to perform operations related to Adaptive Inference Adaptor for Inference Model (NIM) Deployment.

Input devices 7 may include, for example, a keyboard, a mouse, a touchscreen, a microphone, a camera, or any other suitable input device. Output devices 8 may include, for example, a display screen, a speaker, a printer, or any other suitable output device.

Computing device 1 may be implemented using any suitable hardware and/or software configured to perform operations related to Adaptive Inference Adaptor for Inference Model (NIM) Deployment. For example, computing device 1 may be implemented using one or more physical or virtual servers, personal computers, mobile devices, mainframe computers, or any other suitable computing devices.

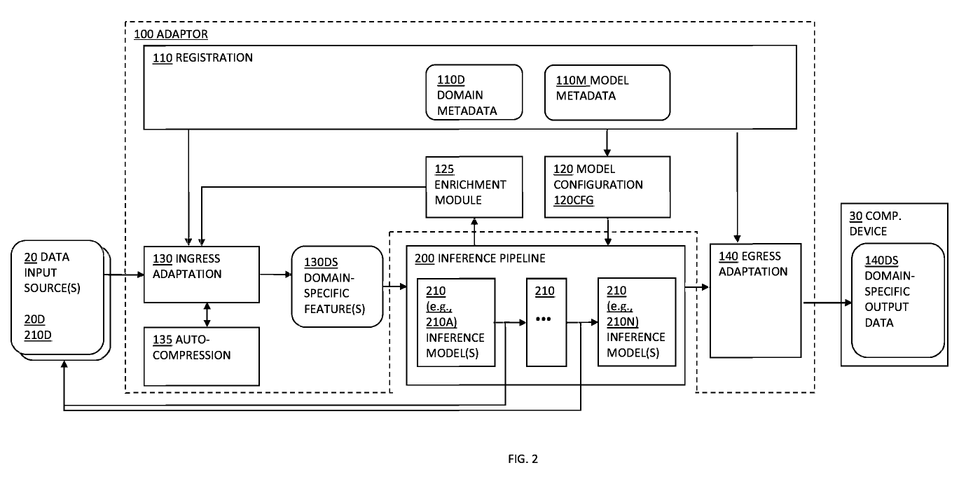

Reference is now made to FIG. 2, which is a block diagram, depicting an adaptor system 100 for managing data flow in an inference pipeline, according to some embodiments. System 100 may include one or more computing devices 1, as described above with reference to FIG. 1. As explained herein, the one or more computing devices 1 may, for example, be configured to perform southbound data adaptation, data enrichment and dimension transformation, northbound data transformation, dynamic data compression and adaptation, and auto-scaling signal generation.

As shown in FIG. 2, arrows may represent flow of one or more data elements to and from system 100 and/or among modules or elements of system 100. Some arrows have been omitted on FIG. 2 for the purpose of clarity.

Inference pipelines are sequences of Machine Learning (ML) models designed to process and analyze data in a structured manner, often used in production environments for real-time decision-making or data processing. For example, in a network security application, an inference pipeline may include ML-based models for traffic analysis, anomaly detection, and threat classification, working together to process incoming network data streams.

As illustrated in FIG. 2, an inference pipeline 200 may include a series of one or more (e.g., multiple) inference models 210. The series of inference models 210 may include a first inference model (denoted 210A), one or more interim ML models 210, and a last inference model 210N. The inference pipeline 200 may be structured as a series of interconnected models, each designed to perform specific data processing tasks.

Data may flow through inference pipeline 200 as follows: Input data 20D from a data input source 20 (e.g., a computing device 1 as depicted in FIG. 1) may enter the pipeline through an ingress adaptation module 130. Ingress adaptation module 130 may translate the input data 20D into a format compatible with the first inference model 210A. The translated data may then be processed sequentially through each of the inference models 210 in the pipeline.

Each inference model 210 in the pipeline may process the information it receives based on its specific function. For example, the first inference model 210A may perform initial data analysis, while subsequent models may refine or expand upon this analysis. The last inference model 210N may generate final output results.

In some cases, an adaptor system 100 may process the translated input data element through at least one inference model 210 to generate at least one inference result. The inference result of pipeline 200 is denoted in FIG. 2 as “domain-specific output data” 140DS.

Adaptor system 100 may manage data flow and optimize performance in inference model pipelines. Adaptor system 100 may serve as an interface between inference pipeline 200 on one hand, and data input source 20 and/or output data 140DS on the other hand, as illustrated in FIG. 2.

As shown in FIG. 2, adaptor system 100 may include various components, including, inter alia, a registration module 110, an ingress adaptation module 130, and auto-compression module 135, an enrichment module 125, a model configuration module 120, and an egress adaptation module 140. By coordinating these various components, adaptor system 100 may provide a flexible and efficient interface between data input sources 20 and inference models 210, optimizing data flow and enhancing the performance of machine learning deployments.

As elaborated herein, Registration module 110 of adaptor system 100 may store and manage model metadata 110M and domain metadata 110D. Configuration module 120 may use this metadata to generate configuration parameters 120CFG, which may guide the operation of other components within adaptor system 100.

Enrichment module 125 may process domain-specific features 130DS generated by ingress adaptation module 130. Enrichment module 125 may add contextual information or perform data transformations to enhance the quality of input data for inference models 210.

Auto compression module 135 may dynamically compress input data based on system requirements and available storage capacity. This compression may help manage data flow and storage efficiency within adaptor system 100.

Ingress adaptation module 130 may transform input data 20D from one or more data sources 20 and/or data 210D from inference models 210, into an ingress data format, that may be processed by inference models 210 of inference pipeline 200. The data in the ingress data format is denoted in FIG. 2 as “domain-specific features 130DS”.

Egress adaptation module 140 may transform the output of inference pipeline 200 into domain-specific output data 140DS. This transformation may ensure that the results of inference models 210 are compatible with downstream systems or applications.

According to some embodiments, registration module 110 may be adapted to receive (e.g., via input 7 of FIG. 1), or collect (e.g., from data source(s) 20 and/or inference model(s) 210) model metadata 110M. Model metadata 110M may be, for example, a data structure (e.g., a table, a list, and the like) that may describe properties of at least one ML-based inference model 210, that may be deployed, or planned to be deployed, in inference pipeline 200.

In some embodiments, registration module 110 may communicate with one or more inference models 210 to automatically register themselves with adaptor system 100. During this registration process, inference models 210 may communicate key information to registration module 110, such as expected data formats and dimensions, as part of model metadata 110M. The automatic registration process may enable adaptor system 100 to dynamically configure its operation for compatibility with newly deployed inference models 210.

Registration module 110 may collaborate with ingress adaptation module 130, to define a required ingress data format for interfacing inference model(s) 210 based on model metadata 110M. Ingress adaptation module 130 may subsequently transform incoming data 20D from data source(s) 20, and/or interim data output 210D of one or more inference models 210, into the required ingress data format. The transformed version of data 20D/210D may subsequently be introduced as input to the appropriate, one or more inference models 210 of inference pipeline 200.

Ingress adaptation module 130 may perform various data translation and transformation operations to ensure that incoming data is properly formatted for processing by inference models 210. In some implementations, ingress adaptation module 130 may handle multiple data formats, including Prometheus metrics, Open Telemetry Protocol (OTLP), proprietary data formats, and various network telemetry formats.

Ingress adaptation module 130 may adapt data in various scenarios. For example, ingress adaptation module 130 may translate input data to provide input data 130DS, globally formatted for inference pipeline 200. This global format may ensure that all data entering inference pipeline 200 is consistently structured and compatible with the requirements of inference models 210.

In another example, ingress adaptation module 130 may adapt the output 210D of one inference model 210 to serve as input for another inference model 210 within inference pipeline 200. This adaptation may enable seamless data flow between different inference models 210 in the pipeline.

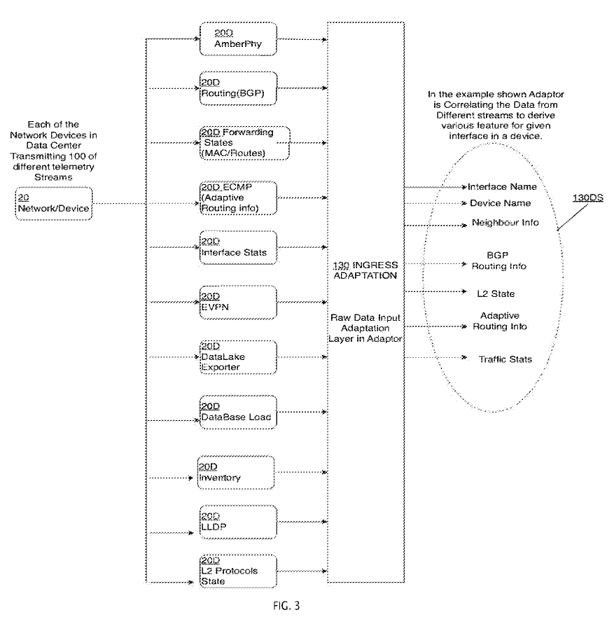

Reference is now made to FIG. 3, which is a block diagram, illustrating an implementation example, where an adaptor system of the present invention may receive a flow of telemetry data from one or more network devices.

As shown in FIG. 3, ingress adaptation module 130 may receive an input data element 20D from data input source 20, and may translate the input data element according to the defined ingress data format. This translation process may ensure that data entering inference pipeline 200 is compatible with the requirements of inference models 210. Adaptor system 100 may thereby streamline the flow of data through inference pipeline 200 by managing the format and structure of input data. Adaptor system 100 may subsequently process the translated input data element 20D through inference model(s) 210 of pipeline 200, to generate at least one domain-specific inference result 140DS.

In the non-limiting example FIG. 3, one or more source devices 20 may generate multiple telemetry streams 20D. These telemetry streams 20D may include various types of networking and device data, and may each have their proprietary structure and format.

In this example, data streams 20D may include data formats such as AmberPhy data, Routing (e.g., Border Gateway Protocol) data, Forwarding States (e.g., Media Access Control (MAC) states, Routes data), Equal-Cost Multi-Path (ECMP) Adaptive Routing information, Interface Statistics, Ethernet Virtual Private Network (EVPN) statistics, DataLake Exporter data, DataBase Load data, Inventory data, Link Layer Discovery Protocol information, Layer 2 Protocols’ state information, and the like.

Ingress adaptation module 130 may receive telemetry streams 20D as incoming data, and apply the required ingress format to this incoming data. This process may involve translating and transforming the raw telemetry 20D data into a standardized format, which is compatible with the inference models 210 in the inference pipeline 200. Through this adaptation process, ingress adaptation module 130 may produce domain-specific features 130DS. In the present example, domain-specific features 130DS may include structured data such as Interface Name, Device Name, Neighbour Info, BGP Routing Info, L2 State, Adaptive Routing Info, and Traffic Stats. The domain-specific features 130DS generated by the ingress adaptation module 130 may then be introduced as input to the inference models 210 within the inference pipeline 200. This standardized input format ensures that the inference models 210 receive data in a consistent and expected structure, regardless of the original format or source of incoming data 20D and/or 210D. By performing this adaptation, ingress adaptation module 130 may enable the adaptive inference adaptor system to handle diverse data sources and formats, providing a flexible and efficient interface between data sources 20 and inference models 210.

According to some embodiments, ingress adaptation module 130 may serve as a gatekeeper for incoming data, ensuring that all data elements 20D conform to the required ingress data format before entering the inference pipeline 200. This gatekeeper functionality may maintain data consistency and compatibility across the entire system. By enforcing a standardized format, ingress adaptation module 130 may help prevent potential errors or inconsistencies that could arise from incompatible or maliciously formatted data.

In some cases, ingress adaptation module 130 may encounter malformed or invalid data elements within the incoming data streams 20D. To maintain data integrity and prevent potential issues in the inference pipeline 200, ingress adaptation module 130 may implement validation checks and filtering mechanisms.

For example, ingress adaptation module 130 may receive a data element 20D that is missing critical fields or contains values outside of expected ranges. Upon detecting such a malformed data element, ingress adaptation module 130 may: (a) Log the occurrence of the malformed data element for auditing and troubleshooting purposes; (b) Attempt to apply predefined error correction or data completion rules, if available; and/or (c) If the data element cannot be corrected or completed, ingress adaptation module 130 may discard the malformed element.

Taking a specific scenario as an example, ingress adaptation module 130 may receive a network telemetry data element 20D that is expected to contain information about interface statistics. However, the received data element 20D may be missing a required "interface name" field. Ingress adaptation module 130 may determine that without a valid interface name, data element 20D cannot be properly processed or associated with the correct network component. Consequently, ingress adaptation module 130 may discard the malformed data element 20D, preventing it from entering the inference pipeline 200 and potentially causing errors or inconsistencies in subsequent processing stages.

By implementing such validation and filtering mechanisms, ingress adaptation module 130 may ensure that only well-formed, valid data elements are passed through to the inference models 210, thereby maintaining the overall reliability and accuracy of inference pipeline 200.

Registration module 110 may be adapted to receive (e.g., via input 7 of FIG. 1), or collect (e.g., from data source(s) 20 and/or inference model(s) 210) domain metadata 110D. Domain metadata 110D may include a data structure (e.g., a table) that may characterize a domain-specific environment of inference models 210 that are deployed, or intended to be deployed within inference pipeline 200. Registration module 110 may collaborate with egress adaptation module 140 to define a required egress data format of domain-specific output data 140DS, based on domain metadata 110D.

Egress adaptation module 140 may be responsible for transforming the output of inference pipeline 200 into domain-specific output data 140DS, in accordance with domain metadata 110D. This transformation process may ensure that the results generated by inference models 210 are compatible with downstream systems or applications within the specific domain of deployment.

Egress adaptation module 140 may interact with other components of adaptor system 100 to ensure proper data formatting. For example, egress adaptation module 140 may communicate with registration module 110 to access domain metadata 110D, which may provide information about the required output format for the specific deployment environment.

Egress adaptation module 140 may operate in various scenarios. For example, egress adaptation module 140 may adapt the output 210D of one inference model 210 to serve as input for another inference model 210 within inference pipeline 200. This adaptation may enable seamless data flow between different inference models 210 in the pipeline, ensuring that the output format of one model matches the input requirements of the next.

In another example, egress adaptation module 140 may adapt the final output of inference pipeline 200, to provide a global outcome or result 140DS of the entire pipeline and/or individual inference models 210. This adaptation may involve consolidating outputs from multiple models, formatting results according to domain-specific requirements, and/or preparing data for integration with external systems.

Adaptor system 100 may employ egress adaptation module 140 to transform at least one first inference result into domain-specific output data 140DS based on domain metadata 110D. This transformation process may involve various operations, such as data format conversion, dimensional adjustments, or the addition of domain-specific context to the inference results.

For example, if inference pipeline 200 is deployed in a network security environment, egress adaptation module 140 may transform raw inference results 210D into output data 140DS, whose format is compatible with security information and event management (SIEM) systems. This may involve converting numerical threat scores into categorical risk levels, adding network-specific identifiers to detected anomalies, formatting results according to industry-standard security event formats, and the like.

By providing flexible output adaptation capabilities, egress adaptation module 140 may enhance the versatility and deployment of inference pipeline 200 across various domain-specific environments. This adaptability may allow adaptor system 100 to seamlessly integrate machine learning models 210 into existing workflows and systems, maximizing the utility of inference results in real-world applications.

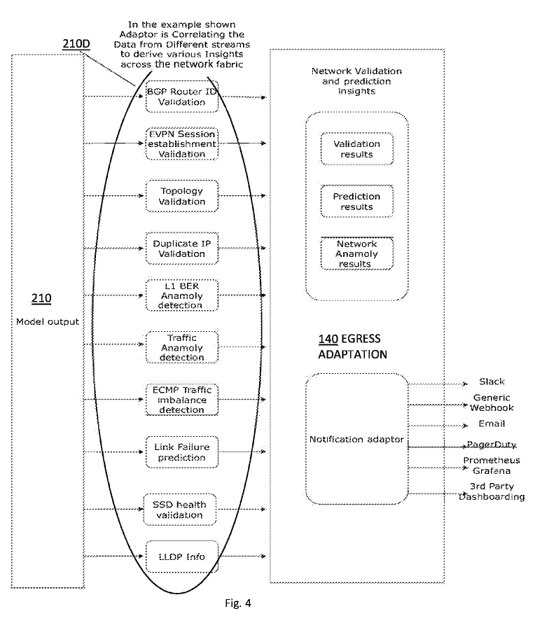

Reference is now made to FIG. 4 which is a block diagram depicting an implementation example where an adaptor system 100 may process inference model output data 210D, according to some embodiments of the invention. As explained herein, the egress data format 140DS may be required for interfacing one or more external computing devices 30 (such as computing device 1 of FIG. 1), e.g., for managing and controlling inference pipeline 200. Adaptor 100 may therefore transform data output 210D of the one or more inference models 210 according to the required egress data format (e.g., based on domain metadata 110D), to provide domain-specific data 140DS to the one or more computing devices 30.

In the example of FIG. 4, one or more inference models 210 within the inference pipeline 200 may generate model output data 210D. Output data 210D may include various types of processed information, such as Border Gateway Protocol (BGP) Router ID validation results, Ethernet Virtual Private Network (EVPN) Session establishment validation outcomes, topology validation data, duplicate Internet Protocol (IP) validation results, Layer 1 (L1) Bit Error Rate (BER) anomaly detection findings, traffic anomaly detection outputs, Equal-Cost Multi-Path (ECMP) traffic imbalance detection results, link failure predictions, Solid-State Drive (SSD) health validation data, and Link Layer Discovery Protocol (LLDP) information, and the like.

Egress adaptation module 140 may receive this model output data 210D as incoming data, and may apply the required egress data format to this incoming data. This process may involve transforming and adapting raw model output 210D into a standardized format that is compatible with domain-specific, downstream systems or applications.

In other words, through this adaptation process, egress adaptation module 140 may produce domain-specific output data 140DS. In the non-limiting example of FIG. 4, domain-specific output data 140DS may include structured information such as validation results, prediction results, and network anomaly results. The egress adaptation layer 140 may process the raw model output 210D and transform it into a format that is suitable for integration with, or consumption by various downstream systems.

For example, domain-specific output data 140DS generated by the egress adaptation module 140 may then be introduced as input to at least one computing device 30 that may be utilized to operate inference pipeline 200. These computing devices 30 may include various systems or applications that consume the processed data, including for example Slack, Generic Webhook, Email, PagerDuty, Prometheus Grafana, and 3rd Party Dashboarding tools.

By performing this adaptation, egress adaptation module 140 may enable the adaptive inference adaptor system 100 to provide flexible output capabilities, ensuring that the results generated by inference models 210 are compatible with various downstream systems, applications, and computing elements 30. This capability may enhance the overall utility and integration potential of inference pipeline 200 in diverse operational environments.

According to some embodiments, adaptor system 100 may include an auto compression module 135, as shown in FIG. 2. Auto compression module 135 may work in conjunction with ingress adaptation module 130 to manage data flow and prevent bottlenecks in inference pipeline 200.

For example, auto compression module 135 may monitor data traffic within inference pipeline 200, and/or at the ingress and egress of inference pipeline 200. Auto compression module 135 may thus identify potential bottlenecks in inference pipeline 200 based on monitoring of a rate of data consumption by inference models 210.

In some embodiments, adaptor system 100 may continuously (e.g., repeatedly, over time) calculate a rate of consumption of incoming input data elements by inference models 210. Based on this calculated rate, adaptor system 100 may dynamically compress one or more incoming input data elements 20D. When a bottleneck is detected during runtime, auto compression module 135 may employ compression techniques to reduce the data volume.

Auto compression module 135 may store the compressed input data elements in at least one storage device (e.g., storage 6 of FIG. 1). This process may allow adaptor system 100 to optimally process incoming data by balancing the rate of data ingestion with the processing capacity of inference models 210.

Adaptor system 100 may provide the stored input data elements to inference models 210 on demand, thereby optimizing the utilization of processing resources in inference pipeline 200, while matching storage availability in the storage device.

Additionally, or alternatively, auto compression module 135 may implement a storage-aware adaptive compression scheme: Auto compression module 135 may monitor storage capacity in real time and dynamically adjust compression levels of incoming data from data input source 20, to manage storage requirements as inference pipeline 200 scales, ensuring efficient use of available storage resources.

In some implementations, adaptor system 100 may include an enrichment module 125, as depicted in FIG. 2. Enrichment module 125 may enhance the quality and context of data flowing through inference pipeline 200.

Enrichment module 125 may process domain-specific features 130DS generated by ingress adaptation module 130. The general function of enrichment module 125 may be to augment input data with additional contextual information or metadata, thereby improving the overall quality and relevance of data processed by inference models 210.

For example, enrichment module 125 may use output data from one inference model 210 to enrich the input data of other associated or corresponding inference models 210 within inference pipeline 200. This enrichment process may involve combining multiple data sources or adding derived features to enhance the information content of the data.

Adaptor system 100 may receive contextual information pertaining to at least one input data element. Adaptor system 100 may employ ingress adaptation module 130 to combine the input data element with the contextual information, generating an enriched version of the input data element.

After enrichment, adaptor system 100 may employ ingress adaptation module 130 to reshape the enriched version according to the ingress data format required by inference models 210. This reshaping process may involve data dimension transformation to ensure that the enriched data maintains the structure expected by inference models 210.

By coordinating the functions of ingress adaptation module 130, auto compression module 135, and enrichment module 125, adaptor system 100 may provide a flexible and efficient mechanism for managing data flow and enhancing data quality within inference pipeline 200.

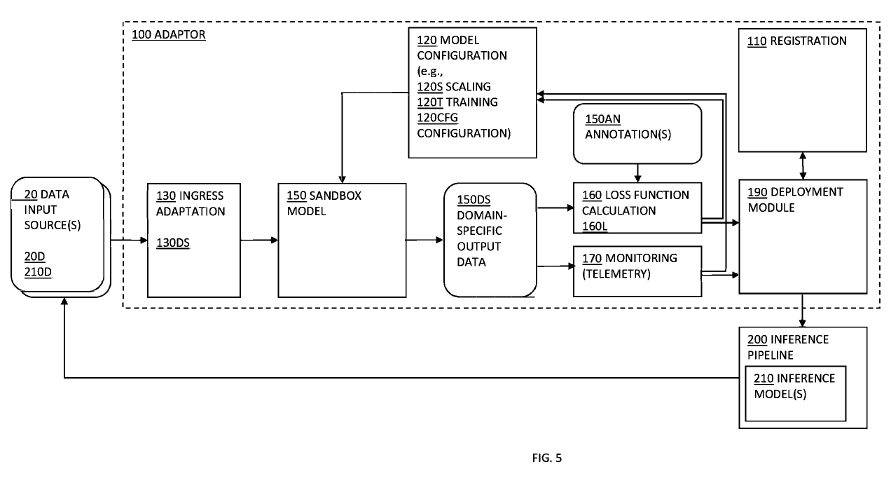

As shown in FIGS. 2 and 5, registration module 110 and configuration module 120 may interact with other components of adaptor system 100 to ensure efficient data flow and processing. For example, registration module 110 may communicate model requirements to ingress adaptation module 130, enabling appropriate data translation for inference models 210. Configuration module 120 may subsequently provide configuration parameters 120CFG to various system components, ensuring consistent operation across adaptor system 100.

For example, configuration parameters 120CFG may include (i) Input data formats, specifying the expected format of incoming data (e.g., such as JSON, CSV, and the like), (ii) Output data formats, defining the format for the system's output, such as JSON, XML, or a custom format (iii) Model type and version, identifying a specific architecture and/or version of an inference model 210 being used; (iv) a logging level, determining verbosity of system logs, with options like DEBUG, INFO, WARNING, ERROR, etc., (v) a caching policy, specifying how and when to cache data or model results, such as "in-memory", "disk-based", "no-cache", and the like, (vi). Timeout settings, defines maximum allowed time for various operations, (vii) a retry policy, specifying how to handle failed operations, (viii) Feature flags, determining utilization of specific modules and features of system 100, such as "enable_autocompression: true" or "use_digital_twin: false", (ix) Threading configuration, defining how many threads to use for parallel processing, (x) Data enrichment rules, defining how to enrich incoming data, for example, "add_timestamp: true" or "include_device_metadata: true"; (xi) Monitoring configuration, specifying what metrics to collect and how often, like "collect_performance_metrics: true" and "metric_collection_interval: 60s". Other such configuration parameters 120CFG are also possible.

Configuration module 120 may also manage scaling parameters 120S and training parameters 120T. Scaling parameters 120S may be used to adjust the processing capacity of inference models 210 based on system load and performance requirements. Training parameters 120T may define settings for training or fine-tuning inference models 210 within adaptor system 100. By managing metadata collection and system configuration, registration module 110 and configuration module 120 may enable adaptor system 100 to flexibly adapt to different inference models and deployment environments. This adaptability may enhance the overall performance and efficiency of data processing within inference pipeline 200, as elaborated herein.

Reference is now made to FIG. 5, which is a block diagram depicting a process of training, and deploying an ML-based inference model 210 in an inference pipeline by adaptor 100, according to some embodiments of the invention.

As shown in FIG. 5, adaptor system 100 may include a sandbox model 150. Sandbox model 150 may be an ML-based model used for training and evaluation purposes within a controlled environment before deployment to inference pipeline 200.

Adaptor system 100 may obtain sandbox model 150 as part of a pre-deployment process. In some implementations, sandbox model 150 may initially represent an untrained version of one or more inference models 210, intended for deployment in inference pipeline 200.

During a training process, adaptor system 100 may receive a training dataset comprising one or more training data elements 20D from data input source 20. Each training data element 20D in the dataset may be annotated 150AN to indicate a corresponding inference result. These annotations 150AN may provide ground truth information for training and evaluating sandbox model 150.

Ingress adaptation module 130 may process the training data elements 20D, translating them into a format 130DS compatible with sandbox model 150. Configuration module 120 may provide configuration parameters 120CFG, training parameters 120T, and scaling parameters 120S to guide the training process.

For example, training parameters 120T may include (i) a learning rate (e.g., a step size at each training iteration), (ii) a batch size (e.g., a number of training examples utilized in each training iteration), (iii) an number of training epochs, (iv) a selection of an optimization algorithm (e.g., Adam, Stochastic Gradient Descent (SGD), and the like), (v) regularization parameters for preventing overfitting, and the like. Other such training parameters 120T are also possible.

Scaling parameters 120S may include, for example, (i) a CPU utilization threshold that triggers scaling actions, (ii) a memory utilization threshold, above which scaling is initiated, (iii) a request rate threshold (e.g., a number of incoming requests per second that prompts scaling), (iv) a minimum number of ML model instances to maintain during low load, (v) a maximum number of ML model instances allowed during peak load, (vi) a cool-down period (e.g., a waiting time between scaling actions to prevent oscillation), (vii) a scaling step size (e.g., a number of instances to add or remove in each scaling action), and the like. Other such scaling parameters 120S are also possible.

Adaptor system 100 may train sandbox model 150 in a controlled environment based on the training dataset. The training process may follow a predetermined training scheme defined by training parameters 120T. Sandbox model 150 may generate domain specific output 150DS based on the input training data.

A loss calculation module 160 may compare domain specific output 150DS with annotations 150AN to calculate a loss function value 160L. Loss function value 160L may indicate accuracy of sandbox model 150 and guide further training iterations.

Adaptor system 100 may continue training sandbox model 150 until a predefined accuracy requirement is met. This accuracy requirement may be specified in training parameters 120T or configuration parameters 120CFG, and may include, for example, achieving a sub-threshold loss function value 160L.

In some cases, adaptor system 100 may further train sandbox model 150 based on computational resource requirements. As elaborated herein, adaptor system 100 may monitor the computational resources consumed by processor 2 during training, using monitoring module 170. Adaptor system 100 may continue training the sandbox model 150 until a predefined computational resource requirement, specified in scaling parameters 120S, is met. Such computational resource requirement may include, for example, a minimal latency or throughput, while maintaining sub-threshold value of processing cycles and/or consumed memory space.

Once sandbox model 150 meets both accuracy and computational resource requirements, deployment module 190 may deploy a copy of trained sandbox model 150 to inference pipeline 200 as one of inference models 210. This process may ensure that deployed models meet performance and efficiency standards before integration into the production environment.

Deployment module 190 may be responsible for managing the deployment and scaling of inference models 210 within inference pipeline 200. Deployment module 190 may interact with other components of adaptor system 100 to ensure efficient implementation and operation of inference pipeline 200. For example, deployment module 190 may communicate with configuration module 120 to obtain configuration parameters 120CFG, scaling parameters 120S, and training parameters 120T necessary for deploying and scaling inference models 210.

In some implementations, deployment module 190 may work in conjunction with a monitoring module 170 to dynamically adjust the deployment of inference models 210 based on system performance and resource utilization. As explained further herein, monitoring module 170 may provide real-time telemetry data to deployment module 190, allowing for adaptive scaling of inference pipeline 200.

Deployment module 190 may implement various scaling strategies to optimize the performance of inference pipeline 200. These strategies may include:

Horizontal scaling: Deployment module 190 may increase or decrease the number of instances of inference models 210 based on the incoming data rate from data input source 20 and the processing capacity of existing model instances.

Vertical scaling: In some cases, deployment module 190 may adjust the computational resources allocated to individual instances of inference models 210, such as CPU, memory, or GPU resources.

Load balancing: Deployment module 190 may distribute incoming data across multiple instances of inference models 210 to ensure efficient utilization of available resources.

According to some embodiments, deployment module 190 may collaborate with registration module 110 to manage the deployment of new inference models 210 or updates to existing models 210. Registration module 110 may provide domain metadata 110D and model metadata 110M to deployment module 190, allowing for proper configuration and integration of new or updated models into inference pipeline 200.

As elaborated herein, adaptor system 100 may include a digital twin model 155, which may emulate functionality of one or more ML-based inference models 210 in a control environment. In some implementations, deployment module 190 may leverage digital twin model 155 to simulate and predict the impact of scaling decisions on inference pipeline 200.

Deployment module 190 may use feedback from accuracy metric module 180 and loss calculation module 160 to guide scaling decisions. For example, if accuracy metrics indicate degrading performance under high load, deployment module 190 may initiate scaling operations to maintain inference quality.

By coordinating with various components of adaptor system 100, deployment module 190 may enable flexible and efficient scaling of inference pipeline 200, adapting to changing computational requirements and ensuring optimal performance in processing data from data input source 20.

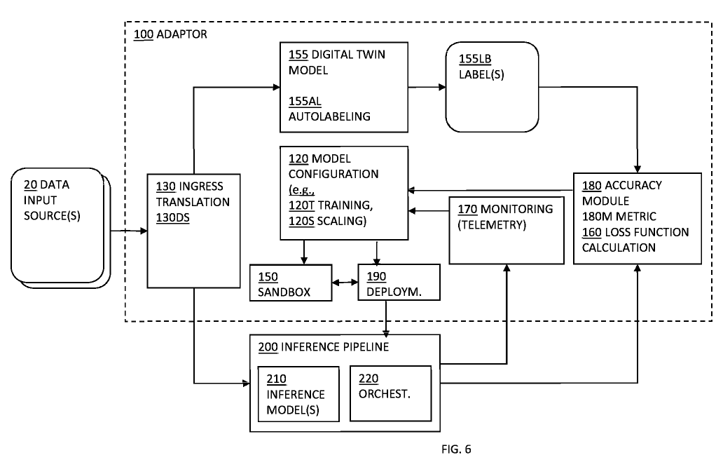

Reference is now made to FIG. 6, which is a block diagram depicting a process of continuous management of an inference pipeline by an adaptor system 100, according to some embodiments of the invention. The adaptor system 100 of FIG. 6 may be the same as adaptor system 100 of FIGS. 2 and 5.

As illustrated in FIGS. 3 and 6, adaptor system 100 may include a monitoring module 170. Monitoring module 170 may track and evaluate system performance of inference pipeline 200 and inference models 210 in real-time.

Monitoring module 170 may function as a telemetry module, collecting data on various aspects of system operation. For example, monitoring module 170 may track computational resource usage, data processing rates, and model performance metrics for inference models 210. This real-time monitoring may enable adaptor system 100 to detect and respond to changes in system performance dynamically.

In some implementations, monitoring module 170 may calculate consumption of computational resources by inference models 210 based on collected telemetry data. This calculation may include metrics such as CPU usage, memory utilization, and processing time for each inference model 210 within inference pipeline 200.

Adaptor system 100 may use the data collected by monitoring module 170 to detect suboptimal inference conditions. Suboptimal conditions may include scenarios such as a strain or backlog due to insufficient inference capacity, where incoming 20D data from data input source(s) 20 exceeds the processing capacity of inference models 210. In another example, a suboptimal condition may include redundant inference capacity, due to a low rate of incoming input data 20D elements, resulting in underutilized computational resources. Other such scenarios of suboptimal operation may also be possible.

Upon detecting a suboptimal inference condition, adaptor system 100 may dynamically adjust configuration of deployed inference models 210. This adjustment may be based on the calculated consumption of computational resources and/or other performance metrics collected by monitoring module 170.

For example, deployment module 190 may communicate an indication of the suboptimal inference condition to an orchestrator 220 of inference pipeline 200. The orchestrator 220 may, for example, be a third-party system such as the currently available Kubernetes or Nomad systems, and may be responsible for managing the deployment and scaling of inference models 210. By providing signals to orchestrator 220, adaptor system 100 (deployment module 190) may trigger auto-scaling of inference capacity, helping to maintain optimal performance of inference pipeline 200.

For example, orchestrator 220 may perform “horizontally auto-scaling of inference capacity, by adding or removing inference model instances based on CPU utilization and request queue length. In another example, orchestrator 220 may implement time-based predictive scaling, adjusting the number of instances according to historical traffic patterns. In yet another example, orchestrator 220 may adapt scaling based on average inference latency, adding instances when latency exceeds a threshold and removing them when it consistently falls below a lower threshold.

FIG. 6 illustrates that adaptor system 100 may include an accuracy metric module 180. Accuracy metric module 180 may work in conjunction with monitoring module 170 to assess the performance of inference models 210 during runtime. As elaborated herein, accuracy metric module 180 may calculate various accuracy metrics 180M to evaluate the accuracy and reliability of inference results produced by inference models 210.

Loss calculation module 160, shown in both FIGS. 5 and 6, may further contribute to ongoing system optimization, by computing loss function values 160L. These loss function values may quantify the difference between expected and actual outputs of inference models 210, providing a measure of model performance.

Accuracy metric module 180 and loss calculation module 160 may collaborate to provide comprehensive performance evaluation of inference pipeline 200. For example, accuracy metric module 180 may compute accuracy metric scores 180M based on predefined benchmarks or validation datasets. Loss calculation module 160 may calculate loss values 160L that indicate how well inference models 210 are performing relative to their training objectives. The combined output from these modules may be used by adaptor system 100 to make informed decisions about model retraining, configuration adjustments, or scaling requirements.

By integrating data from monitoring module 170, accuracy metric module 180, and loss calculation module 160, adaptor system 100 may implement a feedback loop for continuous optimization of inference pipeline 200. This optimization process may involve, for example, (i) Adjusting configuration parameters 120CFG based on performance or accuracy metrics 180M and computing resources’ utilization data from monitoring module 170; (ii) Modifying scaling parameters 120S to trigger auto-scaling when suboptimal inference conditions are detected; and (iii) Updating training parameters 120T if retraining of inference models 210 is deemed necessary based on accuracy 180M or loss metrics 160L.

Through this comprehensive monitoring and optimization approach, adaptor system 100 may maintain efficient operation of inference pipeline 200, ensuring that inference models 210 perform optimally under varying load conditions and data input patterns from data input source 20.

In some cases, adaptor system 100 may include a digital twin model 155, as illustrated in FIG. 6. Digital twin model 155 may be a virtual representation of at least one inference model 210 deployed within inference pipeline 200. Digital twin model 155 may be used to assess and improve the accuracy of inference results generated by inference models 210 during runtime.

Adaptor system 100 may obtain digital twin model 155 as part of its operational setup. Digital twin model 155 may be designed to closely mimic the behavior and characteristics of inference models 210, allowing for parallel processing and comparison of results.

In some implementations, digital twin model 155 may include an auto labeling module 155AL. Auto labeling module 155AL may generate label(s) 155LB for input data processed by digital twin model 155. These label(s) 155LB may serve as reference points for evaluating the accuracy of inference results produced by inference models 210, at run time.

Adaptor system 100 may process translated input data elements 130DS through digital twin model 155, to generate at least one second inference result. This process may occur in parallel with the processing of the same input data by inference models 210 in inference pipeline 200.

During runtime, adaptor system 100 may assess accuracy of at least one first inference result generated by inference models 210. This assessment may be based on at least one second inference result (e.g., label 155LB) produced by digital twin model 155. Accuracy metric module 180 may compare the first inference result (e.g., 210D, 140DS) from inference models 210 with the second inference result (e.g., 155LB) from digital twin model 155 to calculate an accuracy metric score 180M.

When accuracy 180M of the first inference result falls below a predefined threshold, adaptor system 100 may initiate a retraining process for inference models 210. Loss calculation module 160 may subsequently calculate a second loss function value 160L based on the second inference result (155LB) generated by digital twin model 155. This second loss function value may quantify the discrepancy between the expected output (represented by the digital twin model's result 155LB) and the actual output of inference models 210 (e.g., 210D, 140DS).

Adaptor system 100 may subsequently use the second calculated loss function value 160L to retrain at least one deployed inference model 210. The retraining process may involve adjusting model parameters or weights to improve accuracy and align inference models 210 more closely with expected behavior represented by digital twin model 155.

As explained herein, configuration module 120 may provide training parameters 120T to guide the retraining process. These training parameters 120T may define learning rates, batch sizes, or other hyperparameters relevant to model optimization. Monitoring module 170 may track progress of retraining, ensuring that computational resources are efficiently utilized during this process.

By incorporating digital twin model 155 and its auto labeling functionality, adaptor system 100 may implement a continuous improvement loop for inference models 210. This approach may allow for real-time accuracy assessment and model refinement, potentially enhancing overall performance and reliability of inference pipeline 200 in processing data from data input source 20, in real-time or near real time.

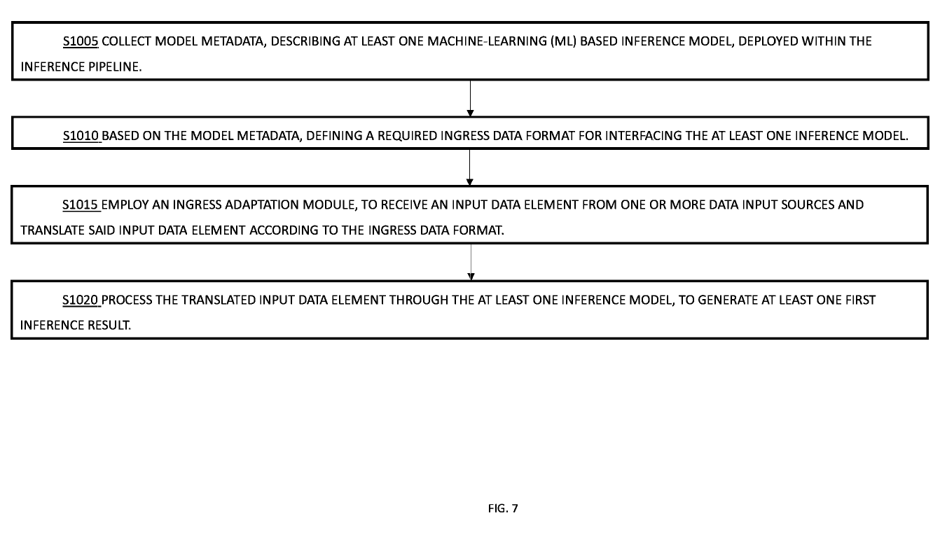

Reference is now made to FIG. 7, which is a flow diagram depicting a method of managing data flow in an inference pipeline by at least one processor (e.g., processor 2 of FIG. 1), according to embodiments of the invention.

As shown in step S1005, the at least one processor 2 may employ a registration module (e.g., element 110 of FIG. 2) that may collect model metadata (e.g., element 110M of FIG. 2). As explained herein, model metadata 110M may describe, or characterize at least one machine-learning (ML) based inference model (e.g., element 210 of FIG. 2) deployed within the inference pipeline (e.g., element 200 of FIG. 2).

As shown in step S1010, the at least one processor 2 may employ a configuration module (e.g., element 120 of FIG. 2) that may, based on the model metadata 110M, define a required ingress data format for interfacing the at least one inference model 210. Configuration module 120 may generate configuration parameters (e.g., element 120CFG of FIG. 2) that may include this required ingress data format.

As shown in step S1015, the at least one processor may employ an ingress adaptation module (e.g., element 130 of FIG. 2) to receive an input data element 20D from one or more data input sources (e.g., element 20 of FIG. 2) and translate said input data element 20D according to the ingress data format. As detailed in the example of FIG. 3, ingress adaptation module 130 may receive input data 20D as telemetry streams, and translate them into domain-specific features (e.g., element 130DS of FIG. 7).

As shown in step S1020, the at least one processor 2 may process the translated input data element 130DS through the at least one inference model 210 to generate at least one first inference result 210D. This processing may occur within inference pipeline 200 of FIG. 2.

As elaborated herein, embodiments of the invention may further include employing an egress adaptation module (e.g., element 140 of FIG. 2) to transform the inference results 210D into domain-specific output data (e.g., element 140DS of FIG. 2). As detailed in the example of FIG. 4, this output data may then be introduced as input to computing devices (e.g., element 30 of FIG. 7) that operate inference pipeline 200.

A number of implementations have been described. Nevertheless, it will be understood that various modifications may be made without departing from the spirit and scope of the disclosure. Accordingly, other implementations are within the scope of the following claims.

1. An adaptor for managing data flow in an inference pipeline, the adaptor operationally connected to a non-transitory memory device, wherein modules of instruction code are stored, and comprising at least one processor associated with the memory device, and configured to execute the modules of instruction code, whereupon execution of said modules of instruction code, the at least one processor is configured to:
collect model metadata, describing at least one machine-learning (ML) based inference model, deployed within the inference pipeline;
based on the model metadata, defining a required ingress data format for interfacing the at least one inference model;
employ an ingress adaptation module, to receive an input data element from one or more data input sources, and translate said input data element according to the ingress data format; and
process the translated input data element through the at least one inference model, to generate at least one first inference result.

2. The adaptor of claim 1, wherein the at least one processor is further configured to:
collect domain metadata, characterizing a domain-specific environment of the at least one deployed inference model; and
employ an egress adaptation module to transform the at least one first inference result into domain-specific output data, based on the domain metadata,
wherein the domain-specific output data is suited for integration with at least one domain-specific downstream system.

3. The adaptor of claim 1, wherein the at least one processor is further configured to:
repeatedly calculate a rate of consumption of incoming input data elements by the at least one inference model;
dynamically compress one or more incoming input data elements based on the calculated rate;
store the compressed input data elements in at least one storage device; and
provide the stored input data elements to the at least one inference model on demand, thereby optimally utilizing processing resources of the inference pipeline, while matching storage availability in the at least one storage device.

4. The adaptor of claim 1, wherein the at least one processor is further configured to:
receive contextual information pertaining to at least one input data element;
employ the ingress adaptation module to combine the at least one input data element with the contextual information, thereby generating an enriched version of the at least one input data element enriching; and
employ the ingress adaptation module to reshape the enriched version according to the ingress data format.

5. The adaptor of claim 1, wherein the at least one processor is further configured to:
employ a telemetry module, to monitor operation of the at least one inference model in real-time;
calculate consumption of computational resources by the at least one inference model, based on said monitoring; and
dynamically adjust a configuration of the at least one deployed inference model, based on the calculated consumption of computational resources.

6. The adaptor of claim 5, wherein the at least one processor is configured to dynamically adjust said configuration by:
detecting a suboptimal inference condition, selected from (a) a strain or backlog due to insufficient inference capacity, and (b) redundant inference capacity, due to a low rate of incoming input data elements; and
communicating an indication of the suboptimal inference condition to an orchestrator of the inference pipeline,
wherein said orchestrator is adapted to rescale inference capacity of the at least one deployed inference model.

7. The adaptor of claim 1, wherein the at least one processor is further configured to:
obtain a digital twin model;
process the translated input data element through the digital twin model, to generate at least one second inference result; and
assess, during run time, an accuracy of the at least one first inference result, based on the at least one second inference result.

8. The adaptor of claim 7, wherein the at least one processor is further configured to:
when said accuracy is below a predefined threshold, calculate a loss function value, based on the at least one second inference result; and
retrain the at least one deployed inference model based on the calculated loss function value.

9. The adaptor of claim 1, wherein the at least one processor is further configured to manage deployment of the at least one inference model by:
obtaining an ML-based sandbox model;
receiving an training dataset, comprising one or more training data elements, wherein each training data element is annotated, to indicate a corresponding inference result;
training the sandbox model in a controlled environment, based on the training dataset according to a predetermined training scheme, until a predefined accuracy requirement is met; and
deploying a copy of the trained, sandbox model in the inference pipeline, as the at least one inference model.

10. The adaptor of claim 9, wherein the at least one processor is configured to:
further train the sandbox model in the controlled environment, based on the training dataset, until a predefined computational resource requirement is met; and
deploy a copy of the trained sandbox model in the inference pipeline, as the at least one inference model.

11. A method of managing data flow in an inference pipeline by at least one processor, the method comprising:
collecting model metadata, describing at least one machine-learning (ML) based inference model, deployed within the inference pipeline;
based on the model metadata, defining a required ingress data format for interfacing the at least one inference model;
employing an ingress adaptation module, to receive an input data element from one or more data input sources, and translating said input data element according to the ingress data format; and
processing the translated input data element through the at least one inference model, to generate at least one first inference result.

12. The method of claim 11, further comprising:
collecting domain metadata, characterizing a domain-specific environment of the at least one deployed inference model; and
employing an egress adaptation module to transform the at least one first inference result into domain-specific output data, based on the domain metadata,
wherein the domain-specific output data is suited for integration with at least one domain-specific downstream system.

13. The method of claim 11, further comprising:
repeatedly calculating a rate of consumption of incoming input data elements by the at least one inference model;
dynamically compressing one or more incoming input data elements based on the calculated rate;
storing the compressed input data elements in at least one storage device; and
providing the stored input data elements to the at least one inference model on demand, thereby optimally utilizing processing resources of the inference pipeline, while matching storage availability in the at least one storage device.

14. The method of claim 11, further comprising:
receiving contextual information pertaining to at least one input data element;
employing the ingress adaptation module to combine the at least one input data element with the contextual information, thereby generating an enriched version of the at least one input data element enriching; and
employing the ingress adaptation module to reshape the enriched version according to the ingress data format.

15. The method of claim 11, further comprising:
employing a telemetry module, to monitor operation of the at least one inference model in real-time;
calculating consumption of computational resources by the at least one inference model, based on said monitoring; and
dynamically adjusting a configuration of the at least one deployed inference model, based on the calculated consumption of computational resources.

16. The method of claim 15, wherein dynamically adjusting the configuration further comprises:
detecting a suboptimal inference condition, selected from (a) a strain or backlog due to insufficient inference capacity, and (b) redundant inference capacity, due to a low rate of incoming input data elements; and
communicating an indication of the suboptimal inference condition to an orchestrator of the inference pipeline,
wherein said orchestrator is adapted to rescale inference capacity of the at least one deployed inference model.

17. The method of claim 11, further comprising:
obtaining a digital twin model;
processing the translated input data element through the digital twin model, to generate at least one second inference result; and
assessing, during run time, an accuracy of the at least one first inference result, based on the at least one second inference result.

18. The method of claim 17, further comprising:
when said accuracy is below a predefined threshold, calculating a loss function value, based on the at least one second inference result; and
retraining the at least one deployed inference model based on the calculated loss function value.

19. The method of claim 11, wherein managing deployment of the at least one inference model comprises:
obtaining an ML-based sandbox model;
receiving an training dataset, comprising one or more training data elements, wherein each training data element is annotated, to indicate a corresponding inference result;
training the sandbox model in a controlled environment, based on the training dataset according to a predetermined training scheme, until a predefined accuracy requirement is met; and
deploying a copy of the trained, sandbox model in the inference pipeline, as the at least one inference model.

20. The method of claim 19, further comprising:
further training the sandbox model in the controlled environment, based on the training dataset, until a predefined computational resource requirement is met; and
deploying a copy of the trained sandbox model in the inference pipeline, as the at least one inference model.
